(19) United States
(12) Patent Application Publication
(10) Pub. No.: US 2002/0075602 A1
(43) Pub. Date: Jun. 20, 2002

(54) Head gimbal assembly flexure arm displacement limiter

(76) Inventors: Markus E. Mangold, Minneapolis, MN (US); David G. Wobbe, Shakopee, MN (US)

Correspondence Address: Westman Champlin & Kelly, 900 Second Avenue South, Suite 1600 - International Centre, Minneapolis, MN, 55402-3319, US

(21) Appl. No.: 09/976,358

(22) Filed: Oct. 11, 2001

Related U.S. Application Data
(60) Provisional application No. 60/256,137, filed on Dec. 15, 2000.

(51) Int. Cl. G11B 5/48

(52) U.S. Cl. 360/245.7

(57) ABSTRACT

A disc drive head gimbal assembly includes a load beam, a gimbal, a disc head slider carrying a tranducing element and a displacement limiter. The load beam has a distal end, a cross member extending across an opening at the distal end, and a load point on the cross member. The gimbal includes a flexure arm to which the disc head slider is mounted for pitch and roll motion about the load point. The displacement limiter includes a pair of first limiter members attached to the cross member adjacent the load point and a pair of second limiter members attached to the gimbal. Each of the second limiter members are positioned to engage one of the first limiter members to limit the vertical displacement of the disc head slider relative to the load beam.

### CROSS-REFERENCE TO RELATED APPLICATION

The present invention claims priority to U.S. Provisional Application No. 60/256,137, filed Dec. 15, 2000 and entitled “LOAD/UNLOAD AND NON-OP SHOCK DISPLACEMENT LIMITER.”

### FIELD OF THE INVENTION

The present invention relates to disc drive storage systems. More specifically, the present invention relates to a displacement limiter of a head gimbal assembly that limits the vertical displacement of a slider relative to a load beam of the head gimbal assembly.

### BACKGROUND OF THE INVENTION

Disc drives are the primary devices employed for mass storage of computer programs and data used in computer systems. Disc drives typically use rigid discs, which are coated with a magnetizable medium for storage of digital information in a plurality of circular, concentric data tracks.

Sliders carry transducers, which write information to and read information from the data tracks. An actuator mechanism moves the slider from track-to-track across the surface of the disc under control of electronic circuitry. The actuator mechanism includes an actuator arm and a head gimbal assembly (HGA) that includes a load beam, a gimbal, and the slider. The load beam applies a downwardly directed load force to the slider through a load point at the gimbal. As the disc rotates, air is dragged and compressed under bearing surfaces of the slider creating a hydrodynamic lifting force that counteracts the load force and causes the slider to lift and “fly” in close proximity to the disc surface. The gimbal includes flexure arms that allow the slider to pitch and roll over the load point while following the typography of the disc.

As disk drives are designed having smaller disks, closer spacing, and increased storage densities, smaller and thinner HGA's are required. The flexure arms of these HGA's are susceptible to damage if the disc drive is subjected to a shock load that causes the slider to pitch or roll excessively. Shock loads can occur during assembly, fly testing, shipping and handling, or as a result of normal wear and tear when, for example, the disc drive is a component of a portable computer.

For contact start/stop (CSS) disc drives, shock loads can also cause damaging contact to occur between the slider and the disc surface. CSS disc drives operate with the slider in contact with the disc surface during start and stop operations when there is insufficient disc rotational speed to maintain the bearing that allows the slider to fly. Thus, when the disc drive is not operating, the slider is “parked” on the disc surface. A shock load can cause the slider to jump off the disc surface and slap against it thereby potentially damaging the slider, the HGA, and/or the disc surface.

Ramp load disc drives provide one solution to this problem. Ramp load disc drives eliminate the need of having to park the slider on the disc surface by using a ramp, typically located adjacent the outer diameter of the disc, from which the slider is loaded above the disc surface and unloaded from the disc surface during start-up and shut-down operations. When the disc drive shuts down, the ramp supports the slider by a lift tab of the load beam and prevents the slider from contacting the disc even when subjected to shock loads, provided that the HGA remains supported by the ramp. As a result, this configuration is less susceptible to damaging contact between the slider and the disc surface caused by a shock load when the disc drive is not operating. However, the gimbal of the HGA in a ramp load disc drive can encounter large vertical forces caused by shock loads while the HGA is being supported by the ramp. These forces can cause the flexure arms of the gimbal to undergo large vertical deflections, which, if unrestricted, can deform the flexure arms and render the HGA inoperable.

To prevent damage caused by such shock loads, some HGA designs include displacement limiters. A displacement limiter is typically adapted to reduce the vertical displacement of the flexure arms of the gimbal to a range that does not lead to permanent deformation of the flexure arms while providing the slider with a sufficient range of motion in the roll and pitch directions to allow the slider the freedom of movement to follow the typography of the disc during normal disc drive operation. These displacement limiters typically include cooperating components, such as tabs, attached to peripheral edges of the load beam and the gimbal. The components engage each other to restrict the relative vertical displacement of the flexure arms of the gimbal relative to the load beam. These prior art configurations generally maximize the distance separating the displacement limiter components and the load point about which the slider pitches and rolls. Unfortunately, this large distance can affect the ability to perform static attitude adjustment to the slider during the manufacture of the disc drive.

The static attitude of the slider is an important performance-related criteria of the HGA. The static attitude refers to the positional orientation of the slider with respect to the surface of the disc over which it is to fly. The slider is generally designed to fly at a predetermined orientation with the surface of the disc. Pitch errors result from deviations in the relative height of the front and back edges of the slider from the desired position and roll errors result from deviations of the relative heights of the sides of the slider from the desired position. Any pitch or roll error in the desired flying attitude of the slider can degrade the performance of the disc drive.

When the slider is mounted to the load beam, it is generally oriented with non-ideal roll and pitch angles. The roll and pitch angles can be forced to their desired setting using a static attitude adjust machine (SAAM). The SAAM twists the load beam along its longitudinal axis to set the desired roll angle of the slider and bends the load beam to set the desired pitch angle of the slider. The angle to which the SAAM twists or bends the load beam must exceed the angle that it ultimately desires the load beam to be set to. This is required to cause the load beam to undergo permanent plastic deformation that results in the fixing of the slider at the desired attitude.

Displacement limiters of the prior art, which are separated from the load point by a large distance, limit range of angles that the SAAM can twist or bend the load beam and, therefore, limit the static attitude adjustment that can be made to the slider. As a result, HGA's having these prior displacement limiters may be required to operate with sliders having non-ideal static attitudes.

### SUMMARY OF THE INVENTION

Presented is a disc drive head gimbal assembly (HGA) having a displacement limiter that is less restrictive to slider static attitude adjustment than those of the prior art. The HGA includes a load beam, a gimbal, and a disc head slider. The load beam has a distal end, a cross member extending across an opening at the distal end, and a load point on the cross member. The gimbal is attached to the load beam at the distal end and includes a flexure arm. The disc head slider is mounted to the flexure arm and is adapted for pitch and roll motion about the load point. The disc head slider also carries a transducing element. The displacement limiter includes a pair of first limiter members attached to the cross member adjacent the load point and a pair of second limiter members each attached to the gimbal and positioned to engage one of the first limiter members to limit the vertical displacement of the disc head slider relative to the load beam. Also presented, is a disc drive storage system that includes the above-described HGA.

These and other features and benefits would become apparent with a careful review of the following drawings and the corresponding detailed description.

### BRIEF DESCRIPTION OF THE DRAWINGS

FIG. 1 is a top plan view of an example of a disc drive storage system with which embodiments of the present invention can be used.

FIG. 2 is a perspective view of a head gimbal assembly in accordance with various embodiments of the invention.

FIG. 3 is a top view of a distal end of a head gimbal assembly in accordance with various embodiments of the invention.

FIGS. 4.1 and 4.2 are cross-sectional views of the head gimbal assembly of FIG. 3 taken along line 4-4 in accordance with various embodiments of the invention.

FIGS. 5.1-5.3 are cross-sectional views of the head gimbal assembly of FIG. 3 taken along line 5-5 in accordance with various embodiments of the invention.

### DETAILED DESCRIPTION OF ILLUSTRATIVE EMBODIMENTS

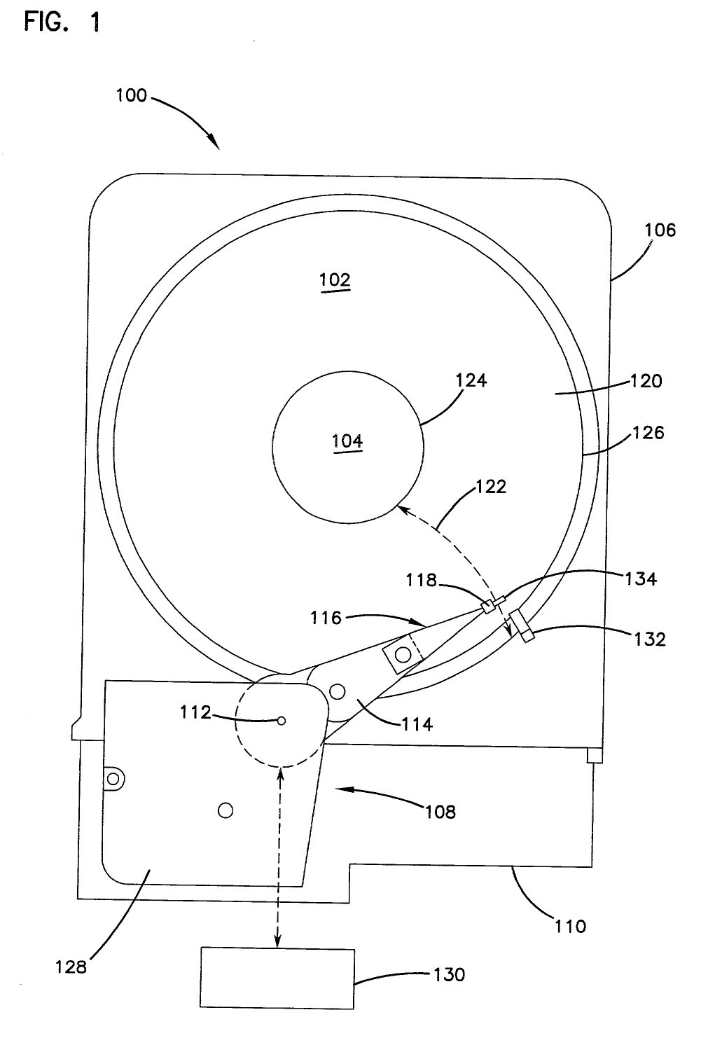

FIG. 1 is a top view of an example of a disc drive 100 with which embodiments of the present invention can be used. Disc drive 100 includes a magnetic disc 102 mounted for rotational movement about an axis 104 and driven by a spindle motor (not shown). The components of disc drive 100 are contained within a housing that includes base 106 and a cover (not shown). Disc drive 100 also includes an actuator mechanism 108 mounted to a base plate 110 and pivotally moveable relative to disc 102 about axis 112. Alternatively, actuator mechanism 108 can be a linear actuator. A head gimbal assembly (HGA) 116 is attached to actuator arm 114 of actuator mechanism 108, and includes a disc head slider 118. Disc head slider 118 includes at least one transducing element for reading information from, and writing information to, disc 102. Actuator mechanism 108 is adapted to rotate HGA 116 and slider 118 along arcuate path 122 between an inner diameter 124 and an outer diameter 126 of disc 102. A cover 128 can cover a portion of actuator mechanism 108.

Drive controller 130 controls actuator mechanism 108 through a suitable connection. Drive controller 130 can be mounted within disc drive 100 or located outside of disc drive 100. During operation, drive controller 130 receives position information indicating a portion of disc 102 to be accessed. Drive controller 130 receives the position information from an operator, from a host computer, or from another suitable controller. Based on the position information, drive controller 130 provides a position signal to actuator mechanism 108. The position signal causes actuator mechanism 108 to pivot about axis 112 and position the transducing element carried by slider 118 at the desired location. Once the transducer is appropriately positioned, drive controller 130 then executes a read or write operation.

During operation of disc drive 100, as disc 102 rotates, air (and/or a lubricant) is dragged under bearing surfaces (not shown) of slider 118 in a direction approximately parallel to the tangential velocity of disc 102. This creates a hydrodynamic lifting force that counteracts a load force provided by HGA 116 and causes slider 118 fly above, and in close proximity to, disc surface 120. HGA 116 allows slider 118 to pitch and roll as it rides on the bearing above surface 120 of disc 102 about a load point through which the load force is applied.

Disc drive 100 can include a ramp 132 or other suitable support mechanism to load slider 118 onto, and unload slider 118 from, disc surface 120 during power-up and power-down operations. When disc drive 100 is to be powered down, actuator mechanism 108, under the control of drive controller 130, rotates HGA 116 to cause a lift tab 134 to engage ramp 132 at outer diameter 126 prior to decelerating the rotation of disc 102. Ramp 132 is configured to support HGA 116 such that slider 118 is held above disc surface 120. Likewise, when disc drive 100 is powered up, disc 102 accelerates to a full operating rotational velocity and drive controller 130 controls actuator mechanism 108 to rotate lift tab 134 of HGA 116 off ramp 132 and position slider 118 over disc surface 120.

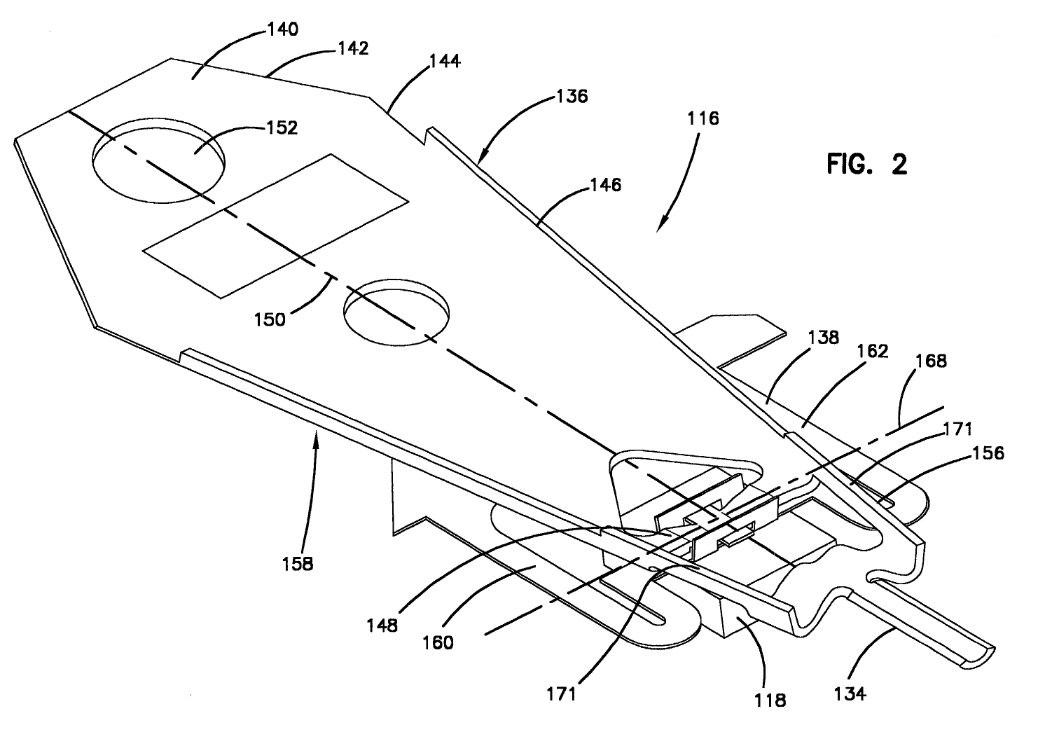

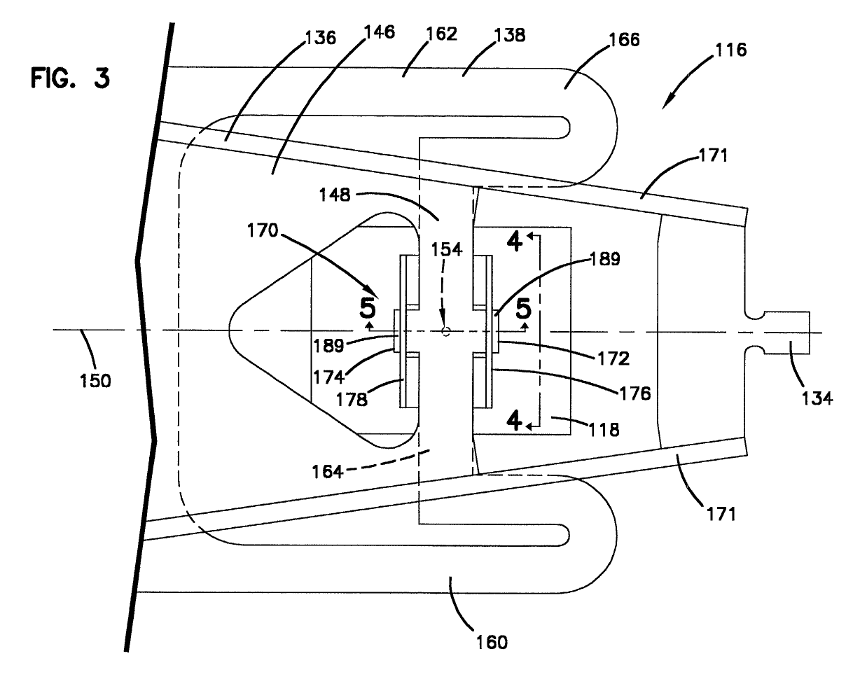

Referring now to FIGS. 2 and 3, a more detailed discussion of the various embodiments of HGA 116 will be provided. HGA 116 generally includes a load beam 136, gimbal 138 and disc head slider 118. Load beam 136 includes a mounting portion 140 at distal end 142, a flexible beam portion 144, a rigid beam section 146, a cross member 148 that extends across an opening 149 of rigid beam section 146, lift tab 134, and a longitudinal axis 150. Mounting portion 140 includes swage hole 152, which mounts to track accessing arm 114 (FIG. 1) through a base plate (not shown). Flexible beam portion 144 applies the load force to gimbal 138 and slider 118 through load point 154. Lift tab 134 is mounted to load beam 136 at proximal end 156. Lift tab 134 is adapted to engage ramp 132 (FIG. 1) when disc drive 100 is in a non-operating state and during load and unload operations.

Gimbal 138 mounts to a bottom side 158 of load beam 136 using conventional methods. Gimbal 138 includes flexure arms 160 and 162, which are connected by a gimbal cross member 164. Slider 118 is mounted to gimbal cross member 164. Load point 154, shown as a dimple on cross member 148 of load beam 136, extends downward toward a top surface 166 of gimbal cross member 164. The attachment of slider 118 through gimbal 138 allows slider 118 to pitch and roll about load point 154 as slider 118 follows the typography of disc 102 (FIG. 1) through the flexing of flexure arms 160 and 162. The roll of slider 118 corresponds to a rotation about longitudinal axis 150 while the pitch of slider 118 corresponds to a rotation of slider 118 about an axis 168 that is transverse to longitudinal axis 150. Cross member 148 is preferably bent downward toward slider 118 near load point 154 to provide greater range of motion for slider 118 to roll.

HGA 116 includes a limiter 170 that is adapted to restrict the vertical displacement of slider 118 and flexure arms 160 and 162 relative to load beam 136. Limiter 170 thereby prevents flexure arms 160 and 162 from undergoing permanent plastic deformation resulting from their excessive displacement relative to load beam 136, which could result in an undesirable change to the static attitude of slider 118. Such an excessive displacement could be caused the support of HGA 116 on ramp 132 by lift tab 134, or by a shock load that occurs while HGA 116 is being supported on ramp 132, while disc drive 100 is operating or while slider 118 is parked on disc surface 120. In accordance with one aspect of the present invention, limiter 170 also provides sufficient freedom of motion in the roll and pitch directions to allow the static attitude of slider 118 to be adjusted in accordance with conventional methods during the manufacturing of disc drive 100.

As mentioned above, it is desired that slider 118 fly above disc 102 at predetermined roll and pitch angles. The roll angle relates to the angle that slider 118 is rotated about longitudinal axis 150 relative to disc surface 120. The pitch angle relates to the angle that slider 118 is rotated about axis 168, which lies transverse to longitudinal axis 150, relative to disc surface 120. When slider 118 is mounted to load beam 136 through gimbal 138, it is generally oriented at undesired roll and pitch angles. The desired angles can be set using a static attitude adjust machine (SAAM). The SAAM includes clamping members that twist and bend rigid beam section 146 in accordance with conventional methods to set the desired roll and pitch static attitudes of slider 118. The amount the SAAM twists or bends load beam 136 must exceed the angle at which it is desired to be set to ensure that load beam 136 undergoes permanent plastic deformation. Unfortunately, some limiters of the prior art are too restrictive to the range of motion that the load beam can be bent or rotated relative to the gimbal or slider thereby limiting the static attitude adjustment that can be made to the HGA. Those skilled in the art understand that as the location of the limiter components is moved further from the load point, there is a reduction in the range of motion that the slider is allowed to pitch and/or roll and there is a reduction in the static attitude adjustment that can be made to the slider. Sliders of the prior art generally maximize the displacement between the limiter components and the load point by positioning the limiter components at a peripheral boundary of the load beam and the gimbal. Limiter 170 of the present invention avoids this problem by locating the components of limiter 170 proximate load point 154 and displaced from side edges 171 of load beam 136.

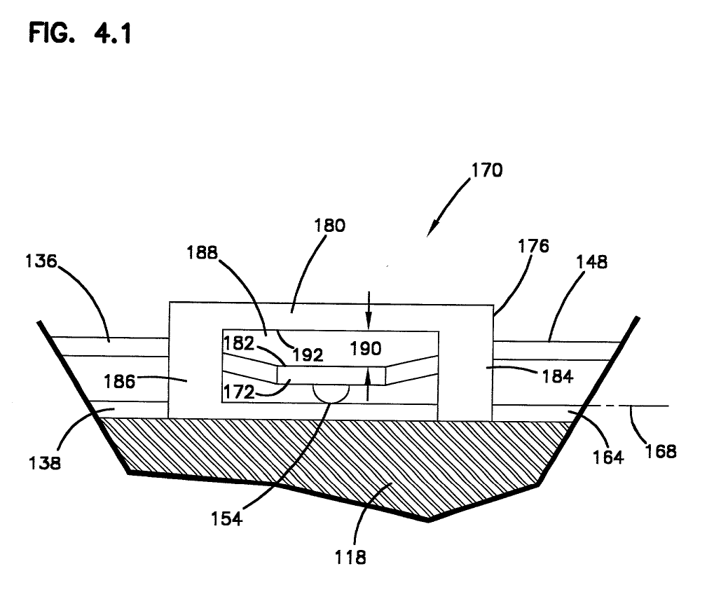

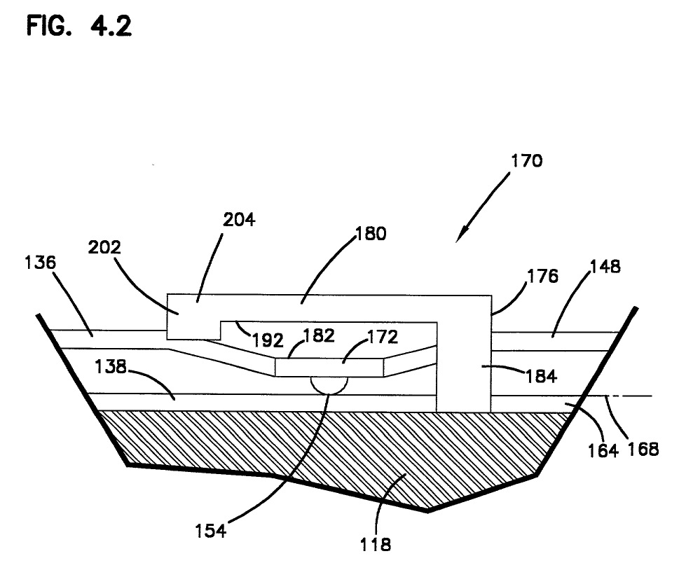

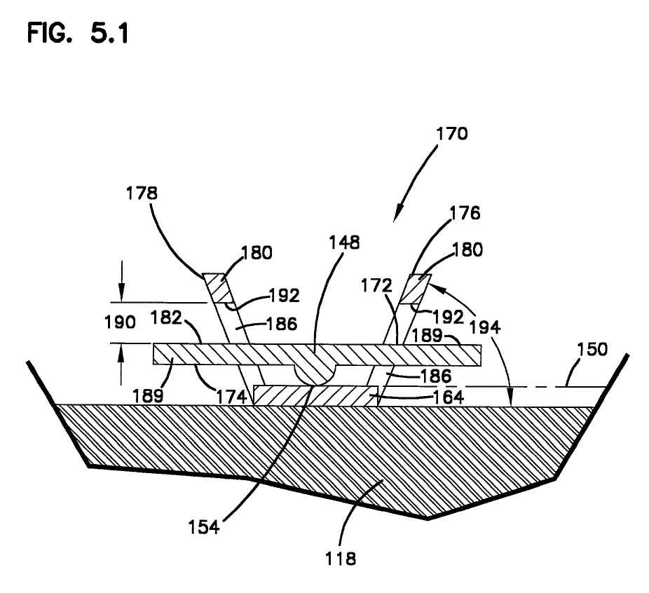

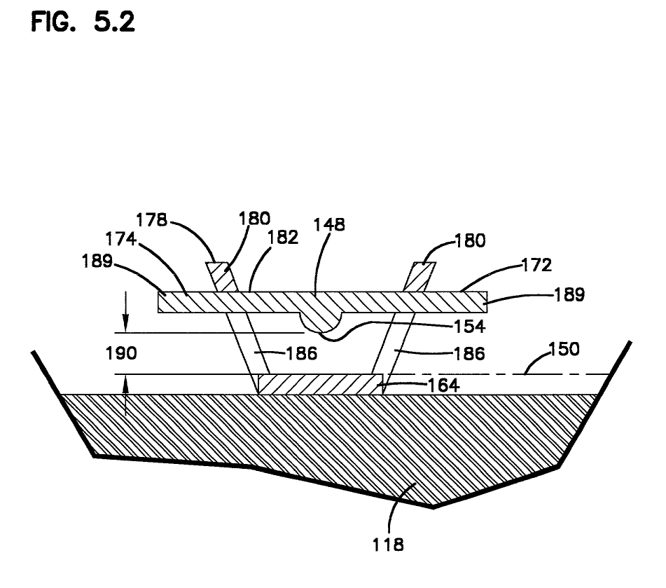

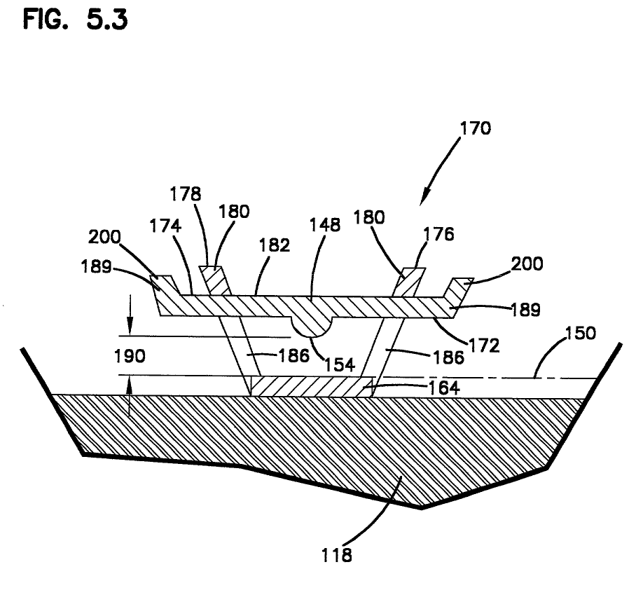

Referring now to FIGS. 4.1-4.2 and 5.1-5.3, a more detailed discussion of limiter 170 will be provided. FIGS. 4.1 and 4.2 are cross-sectional views of HGA 118 taken along line 4-4 of FIG. 3 and FIGS. 5.1-5.3 are cross-sectional views of a portion of HGA 118 taken along line 5-5 of FIG. 3. Limiter 170 includes a pair of first limiter members 172 and 174 mounted to cross member 148 of load beam 136 adjacent load point 154. Gimbal 138 includes a pair of second limiter members 176 and 178 which are adapted to engage a corresponding first limiter member 172 and 174, respectively, to limit the vertical displacement of slider 118 and the bending of flexure arms 160 and 162 relative to load beam 136. Furthermore, the first and second pairs of limiter members provide a balance support of slider 118 and prevent the undesired twisting of flexure members 160 and 162 when HGA 116 is subjected to a shock load and when HGA 116 is supported by ramp 132 at lift tab 134.

In one embodiment, first limiter members 172 and 174 are tab members and the second limiter members 176 and 178 are handles. Handles 176 and 178 include a stop member 180 and the tabs 172 and 174 include a top surface 182 that engages stop member 180 to restrict the vertical displacement of slider 118 relative to load beam 136. In one embodiment, handles 176 and 178 each include a pair of legs 184 and 186 to support stop member 180, as shown in FIG. 4.1. Alternatively, as shown in FIG. 4.2, handles 176 and 178 can include a single leg 184 to support stop member 180. Each handle 176 and 178 includes an opening 188 through which ends 189 of tab members 172 and 174 extend. A gap 190 separates the top surface 182 of tab members 172 and 174 from a bottom surface 192 of stop member 180 and defines the vertical range of motion of slider 118 relative to load beam 136 when gimbal 138 is in contact with load point 154. Gap 190 generally depends on the particular application for HGA 116, but is preferably in a range of 1.5 to 3.0 mils.

As slider 118 flies over disc surface 120, the load force is applied by load beam 136 to slider 118 through load point 154. The load force counteracts a hydrodynamic lifting force that is produced between a bearing surface of slider 118 and disc surface 120 caused by the rotation of disc 102, as shown in FIGS. 4 and 5.1. The unloading of slider 118 from above disc surface 120 involves first rotating HGA 116 by actuator mechanism 108 to cause lift tab 138 to engage ramp 132. As lift tab 134 moves up ramp 132, the hydrodynamic lifting force decreases and slider 118 and gimbal 138 separate from dimple or load point 154. Eventually, top surface 182 of tab members 172 and 174 contact bottom surface 192 of stop member 180 thereby preventing the further vertical displacement of slider 118 and flexure arms 160 and 162 relative to load beam 136, as shown in FIG. 5.2. This unloading process is reversed for the loading process, in which actuator mechanism 108 rotates HGA 118 such that lift tab 134 disengages ramp 132 to position slider 118 over disc surface 120 and resume the relationship between slider 118 and load beam 136 as depicted in FIG. 5.1.

Limiter 170 is preferably formed of a single piece of sheet metal and is welded to load beam 136 with openings 188 of handles 176 and 178 aligned with tab members 172 and 174. After the welding process is complete, handles 176 and 178 are bent along a bend line that is substantially parallel with cross member 148 of load beam 136 to an angle 194, as shown in FIG. 5.1. Angle 194 is preferably at least in the range of approximately 70 to 90 degrees. This bending of handles 176 and 178 causes ends 196 of tab members 172 and 174 to extend through openings 188 and completes the manufacture of limiter 170. The bending of handles 176 and 178 can be performed in accordance with conventional methods and preferably involves pre-defining the bend line by a partial etching process or by forming perforations on gimbal 138 along the desired bend line.

FIG. 5.3 shows a cross-sectional view of a portion of HGA 116 taken along line 5-5 of FIG. 3, in accordance with another embodiment of the invention. In this embodiment, ends 189 of tab members 172 and 174 include vertical or slide restricting portions 200 that are formed by bending ends 189. The slide restricting portions 200 operate to restrict the sliding movement of tab members 172 and 174 and prevent tab members 172 and 174 from slipping through openings 188 of handles 176 and 178, which could render the HGA 116 inoperable. As shown in FIG. 4.2, handles 176 and 178 can also include a slide restricting portion 202 that is adapted to restrict the movement of tab members 172 and 174 along transverse axis 168. Slide restricting portion 202 extends downward from end 204 of stop member 180 opposite leg 184. Many other types of slide restricting portions can also be used to maintain tabs 172 and 174 within openings 188 of handles 176 and 178.

In summary, the present invention relates to a disc drive head gimbal assembly that includes a load beam (such as 136), a gimbal (such as 138), a disc head slider (such as 118) and a displacement limiter (such as 170). The load beam includes a distal end (such as 142), a cross member (such as 148) that extends across an opening (such as 149) at the distal end, and a load point (such as 154) on the cross member. The gimbal is attached to the load beam at the distal end and includes a flexure arm (such as 160 and/or 162). The disc head slider is mounted to the flexure arm and is adapted for pitch and roll motion about the load point. The disc head slider also carries a transducing element. The displacement limiter includes a pair of first limiter members (such as 172 and 174) and a pair of second limiter members (such as 176 and 178). The pair of first limiter members are attached to the cross member adjacent the load point and the pair of second limiter members are attached to the gimbal. Each of the second limiter members is positioned to engage one of the first limiter members to thereby limit the vertical displacement of the slider relative to the load beam.

In one embodiment, either the first or the second pair of limiter members are tab members each having an end (such as 189) and the other of the first or second pair of limiter members are handles having an opening (such as 188) through which the ends of the tab members extend.

In one embodiment, the handles each include a stop member (such as 180) and the tab members each include a top surface (such as 182). Here, the vertical displacement of the disc head slider relative to the load beam is restricted by engagement of the top surface and the stop member. In another embodiment, at least one of the first and second pairs of limiter members include slide restricting portions (such as 200 or 202) that restrict horizontal movement of the first limiter members relative to the second limiter members.

The load beam includes a longitudinal axis (such as 150). In one embodiment, the cross member is aligned with the longitudinal axis. In another embodiment, the first limiter members are tab members that extend along the longitudinal axis. In yet another embodiment, the first and second pairs of limiter members are located substantially along the longitudinal axis of the load beam.

In yet another embodiment of the invention, a disc drive storage system is provided that includes the head gimbal assembly described above.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the HGA while maintaining substantially the same functionality without departing from the scope and spirit of the present invention. In particular, the depicted embodiments of the first and second limiter members could be interchanged while providing the desired vertical displacement limiting and static attitude adjustment functionality described above.

What is claimed is:

1. A disc drive head gimbal assembly comprising:
a load beam having a distal end, a cross member extending across an opening at the distal end, and a load point on the cross member;
a gimbal attached to the load beam at the distal end and having a flexure arm;
a disc head slider mounted to the flexure arm and adapted for pitch and roll motion about the load point, the disc head slider carrying a transducing element; and
a displacement limiter having a pair of first limiter members attached to the cross member adjacent the load point, and a pair of second limiter members attached to the gimbal and each positioned to engage one of the first limiter members to limit the vertical displacement of the slider relative to the load beam.

2. The disc drive head gimbal assembly of claim 1, wherein:
one of the first and second pairs of limiter members are tab members each having an end; and
the other of the first and second pairs of limiter members are handles, the handles each having an opening through which the ends of the tab members extend.

3. The disc drive head gimbal assembly of claim 1, wherein the cross member is aligned with an axis that is transverse to a longitudinal axis of the load beam.

4. The disc drive head gimbal assembly of claim 3, wherein the first limiter members are tab members that extend along the longitudinal axis.

5. The disc drive head gimbal assembly of claim 1, wherein the first and second pairs of limiter members are located substantially along a longitudinal axis of the load beam.

6. The disc drive head gimbal assembly of claim 2, wherein:
the handles each include a stop member; and
the tab members each include a top surface, whereby vertical displacement of the disc head slider relative to the load beam is restricted by engagement of the top surface and the stop member.

7. The disc drive head gimbal assembly of claim 1, wherein at least one of the first and second pairs of limiter members include slide restricting portions that restrict the horizontal movement of the first limiter members relative to the second limiter members.

8. A disc drive storage system including the head gimbal assembly of claim 1.

9. A disc drive storage system comprising:
a housing;
a disc mounted in the housing for rotation about a central axis;
a track accessing arm supported over the disc; and
a head gimbal assembly comprising:
a load beam having a distal end, a cross member extending across an opening at the distal end, and a load point on the cross member;
a gimbal attached to the load beam at the distal end and having a flexure arm;
a disc head slider mounted to the flexure arm and adapted for pitch and roll motion about the load point, the disc head slider carrying a transducing element; and
a displacement limiter having a pair of first limiter members attached to the cross member adjacent the load point, and a pair of second limiter members attached to the gimbal and each positioned to engage one of the first limiter members to limit the vertical displacement of the slider relative to the load beam.

10. The disc drive head gimbal assembly of claim 9, wherein:
one of the first and second pairs of limiter members are tab members each having an end; and
the other of the first and second pairs of limiter members are handles, the handles each having an opening through which the ends of the tab members extend.

11. The disc drive head gimbal assembly of claim 9, wherein the cross member is aligned with an axis that is transverse to a longitudinal axis of the load beam.

12. The disc drive head gimbal assembly of claim 11, wherein the first limiter members are tab members that extend along the longitudinal axis.

13. The disc drive head gimbal assembly of claim 9, wherein the first and second pairs of limiter members are located substantially along a longitudinal axis of the load beam.

14. The disc drive head gimbal assembly of claim 10, wherein:
the handles each include a stop member; and
the tab members each include a top surface, whereby vertical displacement of the disc head slider relative to the load beam is restricted by engagement of the top surface and the stop member.

15. The disc drive head gimbal assembly of claim 9, wherein at least one of the first and second pairs of limiter members include slide restricting portions that restrict the horizontal movement of the first limiter members relative to the second limiter members.

16. A disc drive head gimbal assembly comprising:
a load beam having a distal end and a load point;
a gimbal attached to the load beam at the distal end;
a disc head slider mounted to the gimbal and adapted for pitch and roll motion about the load point; and
a displacement limiting means for restricting the vertical displacement between the disc head slider and the load beam and for providing substantially unrestricted static attitude adjustment of the disc head slider.

17. The disc drive head gimbal assembly of claim 16, wherein the displacement limiting means includes a pair of first limiter members attached to a cross member of the load beam adjacent the load point and a pair of second limiter members attached to the gimbal.

18. The disc drive head gimbal assembly of claim 17, wherein:
one of the first and second pairs of limiter members are tab members each having an end; and
the other of the first and second pairs of limiter members are handles, the handles each having an opening through which the ends of the tab members extend.

19. The disc drive head gimbal assembly of claim 17, wherein the first limiter members are tab members that extend along the longitudinal axis.

20. The disc drive head gimbal assembly of claim 17, wherein the first and second pairs of limiter members are located substantially along a longitudinal axis of the load beam.
